(19) United States
(12) Patent Application Publication
(10) Pub. No.: US 2016/0235510 A1
(43) Pub. Date: Aug. 18, 2016

(54) Compound Oral Cleaning Device

(71) Applicant: Jui-Yu Lin, New Taipei City (TW)

(72) Inventor: Jui-Yu Lin, New Taipei City (TW)

(21) Appl. No.: 14/622,944

(22) Filed: Feb. 16, 2015

(51) Int. Cl. A61C 17/26; A46B 15/00

(52) U.S. Cl. CPC A61C 17/26; A46B 15/0055; A46B 15/0075

(57) ABSTRACT

A compound oral cleaning device includes a first main body, configured with a control circuit, electric power storage unit and driving element in electric connection with each other in sequence at a center thereof; and a second main body, capable of being coupled to the first main body optionally, and a rotating element coupled to said driving element being configured at a center of the second main body. Whereby, the present invention can clean slits between teeth and fur on tongue effectively, and can further carry out the replacement of the rotating element, having both cuticle removing and skin whitening effects after being replaced with a skin rubbing tool.

### TECHNICAL FIELD OF THE INVENTION

The present invention relates to a compound oral cleaning device, and more particularly to a compound oral cleaning device for cleaning slits between teeth and fur on tongue.

### DESCRIPTION OF THE PRIOR ART

Brushing teeth is an important matter for oral cleaning and oral health, and toothbrushes are important tools therefor. Good toothbrushes can make oral cleaning efficiently. Therefore, the market is flooded with all kinds of toothbrushes, divided approximately into traditional toothbrushes and electric toothbrushes.

However, as to traditional toothbrushes, a user must use their palm to hold the handle of a toothbrush with their arm being arched, and twitches it back and forth transversely on the surfaces of teeth; this kind of teeth brushing way is a wrong way, always incapable of riding of residues within the slits of teeth therewith, and even worse, causing dental enamel to be damaged seriously. But, the types of the current electric toothbrushes are more numerous; for example, Taiwan Patent No. 1175778 has a quick assembly function, but the toothbrush handle used as a grasping portion is thicker because it must accommodate batteries and a control circuit so that holding it is rather laborious, not conforming to ergonomics especially for children or persons with smaller hands. Moreover, the structure thereof is too complicated, causing the cost to be higher. Taiwan Patent No. 092731 is the same as Taiwan Patent No. 175772 mentioned above in a handing portion; the both of them do not conform to ergonomics, and the structure thereof is too complicated, being inconvenient for use. Therefore, the current electric toothbrushes need to be improved in structure and design.

### SUMMARY OF THE INVENTION

To design a toothbrush handling portion conforming to ergonomics, simplify the structure of a toothbrush, the present invention is proposed.

One object of the present invention is to provide a compound oral cleaning device, adapted to clean teeth by means of a rotation thereof, a rotating speed and direction thereof being able to be adjusted, namely, the cleaning device being adjusted to rotate downward when a upper row of teeth are brushed, and adjusted to rotate upward when a lower row of teeth are brushed, thereby achieving the effect of the complete cleaning of slits between teeth, and a toothbrush being able to be replaced with a skin rubbing tool, further having both cuticle removing and skin whitening effects.

To obtain the object mentioned above, the present invention proposes a compound oral cleaning device, including: a first main body, at the center of which a control circuit, electric power storage unit and driving element are configured, the control circuit, electric power storage unit and driving element being connected with each other in sequence; and a second main body, coupled to the first main body optionally, a rotating element coupled to the driving element being configured at a center thereof, thereby forming a compound oral cleaning device.

Thereupon, the present invention can clean slits between teeth and fur on tongue, and further can carry the replacement of a rotating element, having both cuticle removing and skin whitening effects after being replaced with a skin rubbing tool.

### BRIEF DESCRIPTION OF THE DRAWINGS

FIG. 1 is an exploded view of a compound oral cleaning device according to the present invention;

FIG. 2 is a perspective view of a compound oral cleaning device according to the present invention;

FIG. 3 is a cross-sectional view of a compound oral cleaning device according to the present invention;

FIG. 4 is a schematic view of a compound oral cleaning device according to the present invention upon use; and

FIG. 5 shows another preferred embodiment of a compound oral cleaning device according to the present invention.

### DETAILED DESCRIPTION OF THE PREFERRED EMBODIMENTS

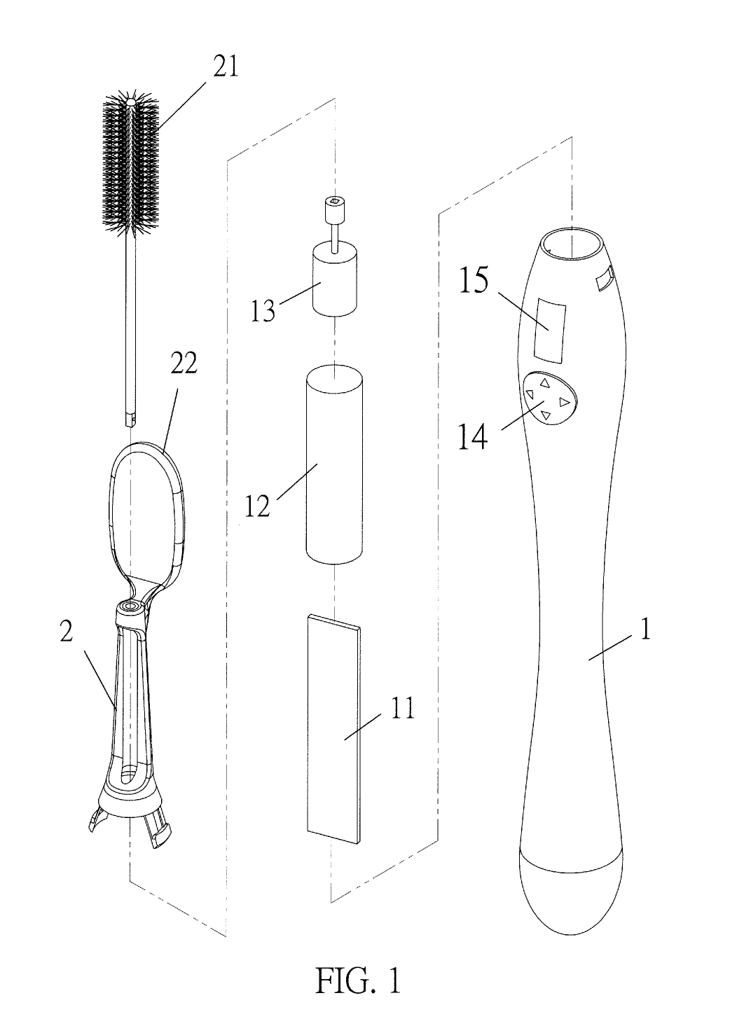

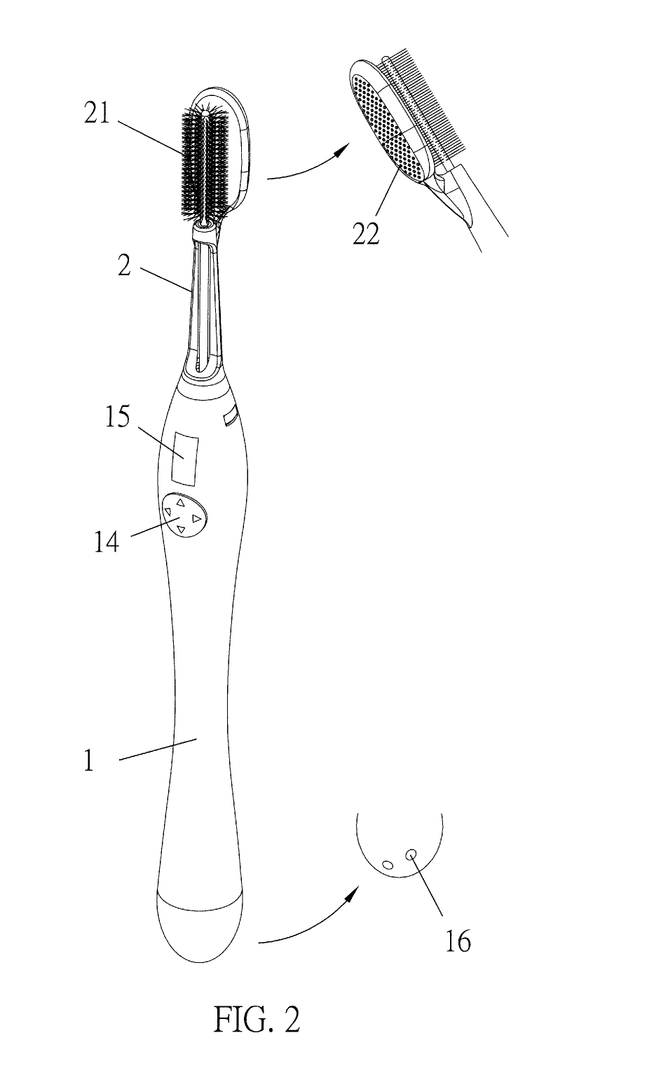

Referring to FIGS. 1 and 2, which respectively are an exploded view and perspective view of a compound oral cleaning device according to the present invention, the compound oral cleaning device includes: a first main body 1, within which a control circuit 11, electric power storage unit 12 and a driving element 13 in electric connection with each other in sequence are configured; and a second main body 2, capable of being coupled to the first main body 1 optionally, a rotating element 21 being configured at the center of the second main body 2, and the rotating element 21 being coupled to the driving element 13. Furthermore, a charging port 16 in electric connection with the control circuit 11 and electric power storage unit 12 is configured on the bottom of the first main body 1, and a control button 14 in electric with the control circuit 11 and adapted to control the forward and reverse rotation and rotating speed of the driving element 13 is further configured on the outside of the first main body 1. Furthermore, the second main body 2 further has a fur cleaning tool 22, and the rotating element 21 may be a toothbrush or skin rubbing tool. In addition, the driving element 13 may be a speed adjustable reversible motor, torque gear motor, or the like. Furthermore, the first main body 1 further has a display 15 for the observation of a motor rotating speed and forward and reverse rotation direction, where the rotating element 21 may be replaced individually or replaced together with the second main body 2. Whereby, a compound oral cleaning device can be formed. According to the present invention, slits between teeth and fur on tongue can be cleaned effectively, and the replacement of the rotating element can further be carried out, having both cuticle removing and skin whitening effects after being replace with the skin rubbing tool.

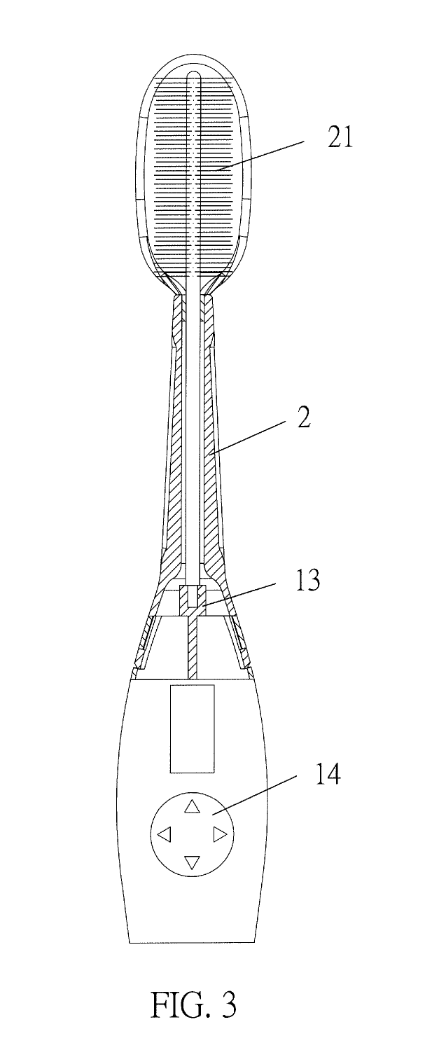

Referring to FIG. 3, which is a cross-sectional view of a compound oral cleaning device according to the present invention, the rotating element 21 is inserted in the second main body 2 to couple to the driving element 13, thereby controlling the rotating speed and rotation direction of the rotating element 21 through the control button 14.

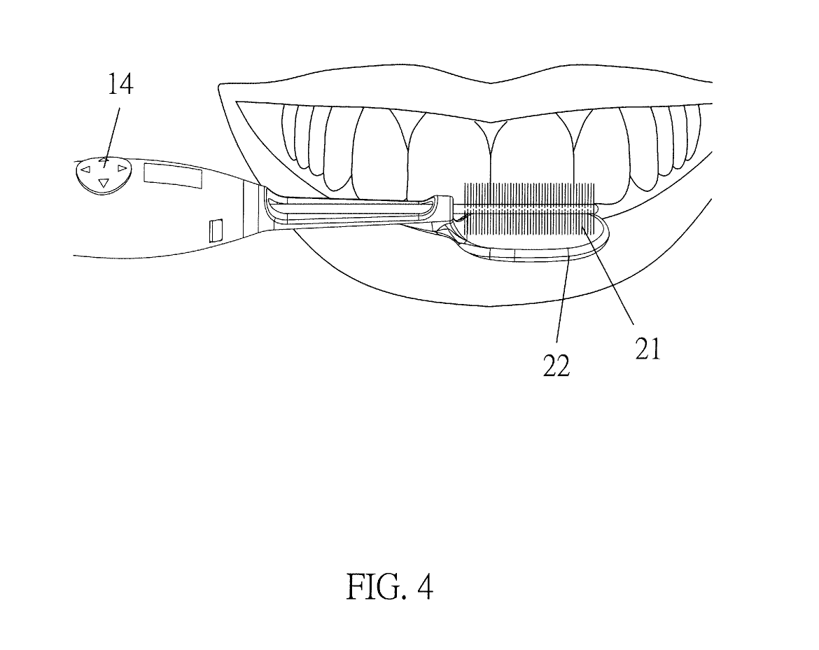

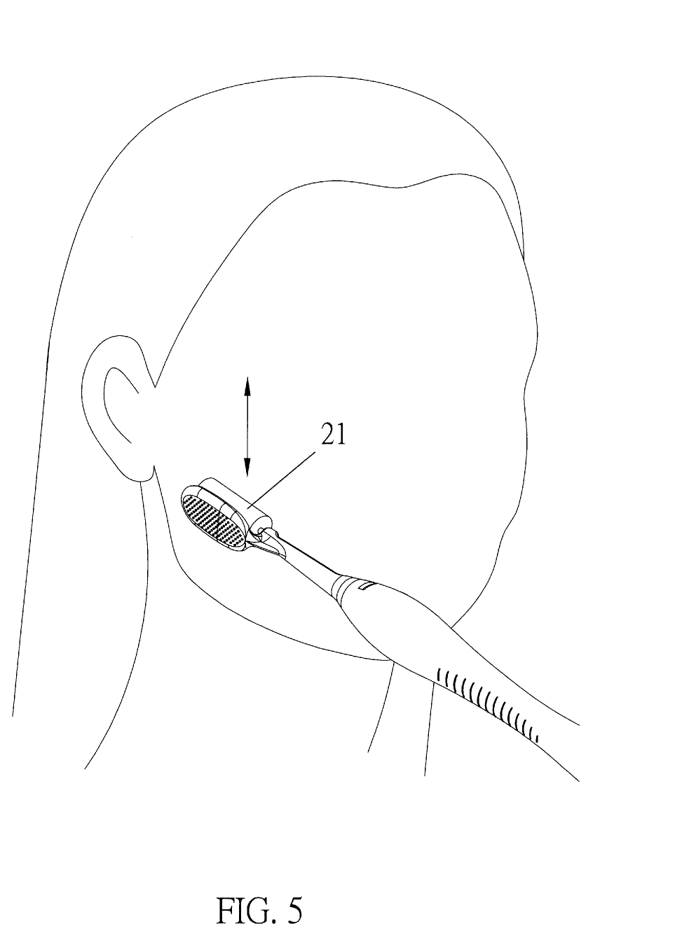

Finally, referring to FIGS. 4 and 5, which respectively are a schematic view of a compound oral cleaning device according to the present invention upon use and a schematic view of another preferred view thereof, the control button 14 may control the rotating speed and rotation direction of the rotating element 21; if a upper row of teeth are brushed, the rotating element 21 is adjusted to rotate upward. On the other hand, if a lower row of teeth are brushed, the rotating element 21 is adjusted to rotate downward. Thereupon, slits between teeth can be cleaned effectively. In addition, the fur cleaning tool 22 is used for the cleaning of fur on tongue. Therefore, according to the present invention, slits between teeth and fur on tongue can be cleaned effectively, and the replacement of the rotating element can further be carried out, having both cuticle removing and skin whitening effects after being replaced with the skin rubbing tool.

The present invention has the following advantages:

1. the present invention is simple in structure and can save the cost because the coupling of the main bodies to each other by means of tenon;

2. the present invention cleans residues in slits between teeth completely because teeth and slits between teeth are cleaned by means of the rotation of the toothbrush;

3. the grasping portion of the present invention is of a streamline form, conforming to ergonomics;

4. the present invention can control the rotation direction and rotating speed of the toothbrush so that residues between teeth can be cleaned completely; and

5. the toothbrush can be replaced with the skin rubbing tool, having both cuticle removing and skin whitening effects

I claim:

1. A compound oral cleaning device, comprising:
a first main body, configured with a control circuit, electric power storage unit and driving element in electric connection with each other in sequence at a center thereof, and
a second main body, capable of being coupled to said first main body optionally, a center thereof has a rotating element coupled to said driving element.

2. The cleaning device according to claim 1, wherein a bottom of said first main body has a charging port in electric connection with said control circuit and electric power storage unit, and a control button and display are further configured on an outside of said first main body, wherein said control button is in electric connection with said control circuit and adapted to control a forward and reverse rotation and rotating speed of said driving element.

3. The cleaning device according to claim 1, wherein said second main body further has a fur cleaning tool.

4. The cleaning device according to claim 1, wherein said rotating element is a toothbrush or skin rubbing tool.

5. The cleaning device according to claim 1, wherein said driving element is a speed adjustable reversible motor of torque gear motor.

6. A compound oral cleaning device, comprising:
a first main body, configured with a control circuit, electric power storage unit and driving element in electric connection with each other in sequence at a center thereof;
a second main body, capable of being coupled to said first main body optionally; and
a rotating element, configured at a center of said second main body and coupled to said driving element.

7. The cleaning device according to claim 6, wherein a bottom of said first main body has a charging port in electric connection with said control circuit and electric power storage unit, and a control button and display are further configured on an outside of said first main body, wherein said control button is in electric connection with said control circuit and adapted to control a forward and reverse rotation and rotating speed of said driving element.

8. The cleaning device according to claim 6, wherein said second main body further has a fur cleaning tool.

9. The cleaning device according to claim 6, wherein said rotating element is a toothbrush or skin rubbing tool.

10. The cleaning device according to claim 6, wherein said driving element is a speed adjustable reversible motor of torque gear motor.
